(19) United States
(12) Patent Application Publication
(10) Pub. No.: US 2007/0143669 A1
(43) Pub. Date: Jun. 21, 2007

(54) Method and system for delivering documents to terminals with limited display capabilities, such as mobile terminals

(76) Inventor: Thierry Royer, Noisy Le Roi (FR)

Correspondence Address: YOUNG & THOMPSON, 745 SOUTH 23RD STREET, 2ND FLOOR, ARLINGTON, VA, 22202, US

(21) Appl. No.: 10/578,675

(22) PCT Filed: Nov. 4, 2004
(86) PCT No.: PCT/FR04/02832

§ 371 Date: Oct. 10, 2006

(30) Foreign Application Priority Data
Nov. 5, 2003 (FR) 0313014

(51) Int. Cl. G06F 17/00

(52) U.S. Cl. 715/523; 715/526; 715/517

(57) ABSTRACT

A method and system delivers documents to terminals with limited display capabilities, such as mobile terminals. More specifically, a method and system adapt a document in order to make same displayable on a terminal with limited display capabilities. The method includes: determining the processing and display capabilities of a terminal; analyzing the document page that is to be displayed by the terminal in order to determine the characteristics thereof, the image resulting from the conversion having a resolution that is selected as a function of the characteristics of the document, such that the contents of the document page are legible on the screen of the terminal; converting one page of a document to a graphical or semi-graphical format that is selected as a function of the processing and display capabilities of the terminal; and transmitting at least part of the image of the converted document page to the terminal.

This invention relates to the delivery of documents to terminals with limited capabilities, in particular in terms of display and storage.

It applies in particular, but not exclusively, to mobile telephony and more specifically to viewing, on a mobile terminal, documents transmitted by means of a data transmission network such as the Internet, which documents are delivered by websites or transmitted as attachments in electronic messages.

With the appearance of new-generation mobile telephone systems such as GPRS (General Packet Radio Service), i-Mode™ and UMTS (Universal Mobile Telecommunications System), telecommunication operators and content editors propose many services accessible to adapted mobile terminals, for example, compatible with WAP protocols (Wireless Application Protocol) and i-mode. These services include in particular information delivery services such as websites or portals and electronic messaging services. The terminals can then recover the contents of documents by applying the technical WAP gateway specifications, in particular using the WTP-SAR (Wireless Transfer Protocol—Segmentation and Reassembly) transmission mode, which segments the contents.

However, the documents, whether they are accessible over the Internet or transmitted as an attachment in an electronic message, can have a variety of different formats. The following can be cited: HTML (HyperText Markup Language) documents, documents from word processing software such as Microsoft Word™ or Adobe Acrobat™, documents from presentation software such as Microsoft Powerpoint™, spreadsheets produced by spreadsheet software such as Microsoft Excel™, images capable of having various different vector or matrix formats such as GIF (Graphics Interchange Format), JPEG (Joint Photographic Experts Group), BMP (BitMaP file format), WBMP (Wireless application protocol BitMaP), PNG (Portable Network Graphics), TIFF (Tag Image File Format), as well as the many derivatives thereof. To be capable of viewing documents in each of these formats, it is necessary to have the appropriate software enabling them to be viewed.

However, due to their small dimensions, mobile terminals have a very limited storage capacity. It is therefore impossible to install in memory all of the software enabling documents to be viewed, even the most common document formats. In addition, the display screen dimensions of a mobile terminal are very small by comparison with the display screen of a desktop computer.

For these reasons, the contents of these documents generally cannot be displayed on the screen of the terminal and the user can consult them only if he or she has a desktop or portable computer.

Some formats such as HTML, which is the most commonly used format for delivering documents via the Internet, have, however, been adapted to mobile telephony. In this regard, cHTML (compact HTML) designed for i-Mode systems and WML (Wireless Markup Language) format designed for the WAP protocol can be cited. This solution has the disadvantage of providing access only to document formats adapted to mobile telephony.

Moreover, there are many different mobile terminal models having a wide variety of display screen dimensions and storage capacities. When displaying a document, it is also necessary to consider the capabilities for vertical and/or horizontal scrolling of the terminal, which can also very from one model to another.

U.S. Pat. No. 6,611,358 describes a document conversion system suitable for displaying documents on a mobile telephone, and taking into account the display capabilities of the latter. However, this patent does not make it possible to display any type of document, and in particular files containing text, on a mobile terminal. Nor does it make it possible to adjust the resolution of an image displayed on a terminal according to the contents of the image and the display capabilities of the terminal, so as to facilitate the reading of the document by the user.

This invention aims to overcome these disadvantages. This objective is achieved by providing a method for adapting a document so as to make it viewable on a terminal having limited display capabilities, which method includes the following steps:
determining the processing and display capabilities of a terminal,
converting a page of a document into a graphic or semi-graphic format chosen on the basis of the processing and or display capabilities of the terminal, and
at least partially transmitting the image of the converted document page to the terminal.

According to the invention, this method includes steps consisting of analyzing the document page to be displayed by the terminal so as to determine its characteristics, wherein the image resulting from the conversion has a resolution selected on the basis of the document characteristics, so that the contents of the document page can be read on the screen of the terminal.

According to a preferred embodiment of the invention, the determination of the processing and display capabilities of the terminal comprises a step of determining a display axis corresponding to an axis of a larger dimension of an image capable of being displayed by the terminal, wherein the analysis of the document page to be displayed comprises a step of determining a reading direction of the document page, and the conversion of the document page is followed by a step of adapting the image resulting from the conversion, consisting of making the reading direction of the document page coincide with the display axis of the terminal.

According to a preferred embodiment of the invention, this method also includes a step of extracting, from the image resulting from the conversion, a band of which the dimensions correspond to the maximum dimensions of an image capable of being displayed by the terminal, and of which the orientation in the image corresponds to the reading axis of the document page, which image band is transmitted to the terminal.

According to a preferred embodiment of the invention, the resolution of the image generated by the conversion of a document page is determined on the basis of the size of alphanumeric characters present in the document page and on the basis of the dimensions of the page.

According to a preferred embodiment of the invention, this method includes a preliminary step of selecting a portion of a document page to be displayed on the screen of the terminal including steps consisting of converting the document page into a reduced image having a format compatible with the processing and display capabilities of a terminal, and with a resolution selected so that the entire image can be displayed by the terminal, and transmitting the reduced image of the page to the terminal, wherein the user of the terminal then has the possibility of selecting an area of the displayed image, which selected area of the document page is then converted to a resolution selected on the basis of the characteristics of the document page, so that the contents of the document page can be read on the screen of the terminal.

Advantageously, if the document page is an image representing text, the analysis of the document page includes steps of recognizing the alphanumeric characters present in the document page and determining a main size of the recognized alphanumeric characters, with the resolution of the image generated by the conversion of a document page being determined on the basis of the main size obtained.

According to a preferred embodiment of the invention, the analysis of the document page consists of separating images and text contained on the page, wherein the conversion of the document page consists of generating, based on the text, images in an adapted format, and converting the format of the images so that they can be viewed on the terminal.

The invention also relates to a system for adapting a document so as to make it viewable on a terminal having limited display capabilities, which system includes an adaptation module comprising means for determining processing and display capabilities of a terminal, and means for converting a page of a document into a graphic or semi-graphic format selected on the basis of the processing and display capabilities of the terminal, which system also includes means for at least partially transmitting the image of the converted document page to the terminal.

According to the invention, the adaptation module also includes means for analyzing the document page to be displayed by the terminal, so as to determine its characteristics, wherein the image resulting from the conversion has a resolution selected on the basis of the characteristics of the document, so that the contents of the document page can be read on the display screen of the terminal.

According to a preferred embodiment of the invention, the means for determining the processing and display capabilities of the terminal include means for determining a display axis corresponding to an axis of a larger dimension of an image capable of being displayed by the terminal, wherein the means for analyzing the document page to be displayed comprise means for determining a reading direction of the document page, the adaptation module includes means for adapting the image resulting from the conversion causing the reading direction of the document page to coincide with the display axis of the terminal.

According to a preferred embodiment of the invention, the adaptation module also includes means for cutting the image resulting from the conversion into bands of which the dimensions correspond to the maximum dimensions of an image capable of being displayed by the terminal, and of which the orientation in the image corresponds to the reading axis of the document page, and means for successively transmitting the image bands of the document page image to the terminal.

The adaptation module is advantageously integrated in a web server delivering documents to mobile terminals.

Alternatively, the adaptation module is integrated in a gateway providing the interconnection between a mobile telephone network to which the terminals are capable of being connected, and a data transmission network providing access to documents capable of being viewed on the terminals.

The adaptation module is alternatively integrated in a specialized server connected to a data transmission network providing access to documents capable of being viewed on the terminals, wherein the terminals are mobile terminals capable of being connected to a mobile telephone network interconnected with the data transmission network.

A preferred embodiment of the invention will be described below, by way of a non-limiting example, with reference to the appended drawings in which:

FIG. 1 shows a system for delivering documents in a mobile network according to the invention;

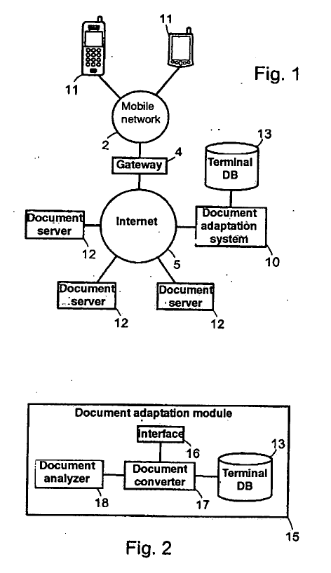

FIG. 2 diagrammatically shows an adaptation module according to the invention;

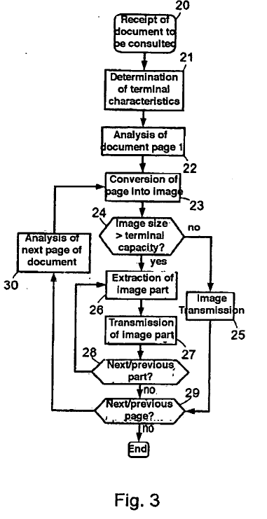

FIG. 3 shows, in the form of a flow chart, a procedure for delivering a document.

The system shown in FIG. 1 includes a mobile network 2 to which the user terminals 11, 12 can be connected, and at least one gateway 4 connecting the mobile network to a data transmission network 5 such as the Internet. The network 5 provides access to document delivery servers 12 such as websites, suitable for delivering documents in HTML format or derivatives thereof such as cHTML, xHTML or WML over the Internet.

The mobile terminals 11 can be mobile telephones or personal data assistants (PDAs) equipped with a mobile telecommunication interface.

The document servers can be information sites, electronic commerce sites presenting, for example, product data sheets, or service sites, such as, for example, search engines or messaging sites offering, via a web interface, the possibility of sending and receiving electronic messages capable of being associated with attachments.

Although mobile terminals designed for accessing the Internet can display documents in HTML format its derivative thereof, they generally cannot display documents in other formats which are, however, accessible on the Internet, for example, in the form of an attachment in an electronic message or delivered over an information site.

To be able to view any type of document on a mobile terminal, at least some of the servers 12 are equipped with a document adaptation module according to the invention making it possible to adapt a document so that it can be viewed on a mobile terminal 11. This module can alternatively be integrated in the gateway 4.

In another alternative of the invention, this module is integrated in a specialized server 10 that receives documents to be adapted and, in return, transmits all or some of each document received, in a form suitable for the characteristics of a mobile terminal of which the type has been specified in association with the document to be adapted. The documents to be adapted can be transmitted by the gateway 4 or by the servers 12 upon the request of the mobile terminal users.

The document adaptation performed by the adaptation module according to the invention consists of converting the document into one or more images in a format adapted to the terminal, then if the size of the image is too large for the terminal's capabilities, cutting the image into parts and transmitting these image parts one after another, upon the user's command.

More specifically, the adaptation module is designed to identify the terminal and determine the characteristics thereof, transform a document or make use of such a transformation service, so as to convert it from its original format into a graphic or semi-graphic format supported by the terminal, and manage a dialogue with the terminal to which it transfers, upon the request of the terminal and according to the possibilities thereof, the pages or parts of pages of the document in graphic or semi-graphic format. If the terminal cannot run local application software, the adaptation module includes the page or page part in graphic or semi-graphic format in a document readable by the terminal in which commands are also inserted enabling the user to request the next or previous part of the document in graphic or semi-graphic format.

As shown in FIG. 2, the adaptation module 15 according to the invention includes an interface 16 whereby all requests to convert documents and to transmit parts of converted documents are received, a document converter 17 designed to convert any type of document into an image of which the format has previously been specified, and a document analyzer 18 designed to analyzed the contents of the document to be converted, in particular so as to determine the resolution to be used for the conversion of the document, so that the latter will be readable or comprehensible on the terminal.

In addition, the adaptation module 15 includes or has access to at least one database 13 combining the characteristics of all mobile terminals on the market, capable of accessing documents delivered via the Internet.

The database 13 combines, for each terminal type, particularly some of the following information:
a terminal model identifier,
the dimensions (width, height) in number of pixels of the screen of the terminal,
the dimensions (width, height) in number of pixels of an image capable of being displayed by the terminal with vertical and/or horizontal scrolling,
the maximum size of an image capable of being displayed by the terminal,
the display mode of the terminal, in color/gray levels,
the number of colors or gray levels,
the image coding formats supported by the terminal (GIF, JPEG, BMP, WBMP, PNG, TIFF, etc), p0 the display protocol of the terminal (cHTML, WML, etc),
the possibility of running small applet-type programs, the programming languages supported by the terminal,
the memory available for loading an running such programs, for loading and displaying images, and for the resources of the terminal,
the function keys of the terminal capable of being used to specify a part of the image to be displayed,
and so on.

To perform such an analysis, the document analyzer 18 includes a set of applications designed to read electronic documents of different predefined formats. The analysis of a document consists of determining the number of pages of the document and the dimensions of each of the pages. In the case of documents containing text or more generally alphanumeric characters, it also consists of determining the size of the alphanumeric characters used. The dimensions of a document page and the size of the characters used in the page then serve to determine the resolution to be applied when converting the page into an image.

In an advantageous embodiment of the invention, the analysis of a document also consists of determining the reading direction of each page on the basis of the language. Thus, for Western languages, the reading direction is from left to right and from top to bottom.

The converter 17 is designed in particular to determine a conversion operation according to the format of the document to be converted and the format into which the document will be converted, selected on the basis of the terminal; and possibly the type of document, as well as the resolution to be used in the conversion of the document. To this end, the converter 17 uses a set of applications respectively adapted to the various conversions capable of being performed.

The analyzer 18 and the converter 17 are advantageously designed so as to easily integrate additional applications in order to be capable of handling additional document formats.

FIG. 3 shows, in greater detail, an example of a procedure 20 performed by the adaptation module 15 in order to process a document received in any format and transmit it to a mobile terminal in a format that can be displayed by the latter.

The procedure 20 first includes a step of determining the characteristics of the terminal 11. This step consists in particular of finding an identifier of the terminal model, for example by means of the “user-agent” parameter provided in the HTTP protocol. This identifier makes it possible to find the characteristics of the terminal in the database 13.

In the next step 22, the adaptation module 15 analyzes the document to be transmitted to the terminal in order to determine the format thereof, the number of pages that it contains, etc., and, if it is a document containing text, the dimensions of the first document page and the main size of the alphanumeric characters used on this page or the smallest character size substantially used.

If the document does not contain text, a resolution suitable for A4-size document pages and an alphanumeric character size selected by default, for example, 10, can be chosen.

In an alternative of the invention, in the case of a document containing a matrix image representing text, the analysis of the document by the adaptation module 15 makes use of a character recognition tool (OCR) in order to convert the parts of the image representing text into text, so as to be capable of determining the size of the text and thus the resolution to be used when converting the document into an image that can be displayed by the terminal, so that the text of the document displayed on the screen of the terminal can be read by the user.

In the next step 23, the first page of the document is converted into a coded image in a format accepted by the terminal, respecting the layout of the document, wherein the main size of the alphanumeric characters, determined in the previous step, is used to determine the optimal resolution of the image thus generated, so as to enable it to be read on the screen of the terminal, without excessively increasing the size. Thus, a page of text of size A4/portrait orientation, using a character font of 10 to 12, can be converted into an image of 590×840 pixels.

If the terminal supports a plurality of image coding formats, the format of the image that is generated can also be chosen on the basis of the type of information contained on the page. Thus, a page containing text and figures is preferably converted into GIF or PNG format, while a page containing photographs is converted into JPEG format.

In the next step 24, the adaptation module compares the image thus generated with the maximum image size allowed by the terminal. If the image size is acceptable by the terminal, the adaptation module performs step 25 consisting of inserting the image into a file containing commands according to the display protocol of the terminal (for example, cHTML), and in particular a command enabling the user to obtain the next or previous page of the document, if the document has more than one page. The file thus generated is then transmitted to the terminal.

In the next step 29, if the document has more than one page and the user has activated the next page command, the adaptation module will execute step 30 consisting of analyzing the next page of the document, and then repeat the sequence of steps described above, starting with the step 23 of converting the analyzed page into an image.

If, in step 24, the image size generated is larger than the maximum size allowable by the terminal, said image is cut in step 26 into a plurality of bands of which the size corresponds to the maximum size acceptable by the terminal. It is possible to optionally overlap these bands so as to facilitate the reading of the document, in particular to integrate the lines or words cut off when the image was cut into bands.

In the next step 27, the adaptation module inserts the first image band obtained in the previous step into a file containing two commands according to the display protocol of the terminal (for example cHTML), and in particular commands enabling the user to obtain the next band of the image and the next page of the document if the document has more than one page. The file thus generated is then transmitted to the terminal.

Once the image band has been transmitted in step 27, the adaptation module moves on to step 28, in which it receives the commands to display the previous or next band of the image generated, and returns to step 26 if the user has commanded another image band, or moves on to step 29 if the user has sent another command.

In steps 25 and 27, the orientation of the extracted image band or the image that is inserted into the file transmitted to the terminal is adapted so as to maximize the display capabilities of the terminal and in particular the capabilities for image scrolling on the screen. Thus, if the terminal accepts images that are taller than the height of the display screen, by integrating vertical scrolling, or if the terminal has a screen that is higher than it is wide without a scrolling capability, it is advantageous to pivot the image to be displayed 90° in clockwise direction (in the case of text in a Western language), with the image thus pivoted 90° then being inserted into the file which is transmitted to the terminal.

Thus, for example, if the terminal has a screen 120 pixels wide and 130 pixels high, with a vertical scrolling capacity of 390 pixels, the image to be transmitted is cut into bands no more than 390 pixels wide and 120 pixels high. Each band is then pivoted 90° so as to obtain a band that is 120 pixels wide and 390 pixels high, and is then inserted into a file which is transmitted to the terminal. When such a file is displayed on the screen of the terminal, the user can view it correctly simply by pivoting his or her terminal 90° in the counter-clockwise direction, and by possibly actuating the scroll command so as to view the right-hand side of the image transmitted.

In the step 22 of analyzing a document page, a reading axis (for example, from left to right for a page in a Western language) and a display axis, determined by the largest dimension in number of pixels of the maximum image size allowable by the terminal (in the previous example, from top to bottom), are thus defined. In step 25, the image that is inserted into the file transmitted to the terminal is possibly pivoted so that its reading axis coincides with the display axis of the terminal. Similarly, in step 26, the image band to be extracted from the image is determined so that the axis of its largest dimension coincides with the reading axis of the document. This band is then inserted into the transmitted file so that the axis of its largest dimension coincides with the display axis of the terminal.

In addition, some terminals are capable of running small applet-type programs. In this case, the adaptation module 15 executes procedure 20 by performing step 25, in which the generated image is transmitted to the terminal, according to the limit of its storage capacity, in a single operation or by blocks, in a file containing a program for managing the vertical, and, if necessary, horizontal, scrolling of the image. Of course, if the terminal contains such a scrolling management program, it is not necessary to integrate such a scrolling management program.

The display axis of the terminal then corresponds to the largest dimension of the display screen, and the image can be pivoted as above so that this display axis coincides with the reading axis of the page.

In an alternative of step 26, for a terminal capable of loading onboard applications, the adaptation module advantageously transmits the image of the full page into a reduced format adapted to the maximum image size capable of being displayed by the terminal and, if this is possible, all or some of the full image to the chosen readability resolution. The user can then, by moving a cursor representing the reading area on the display screen of the terminal (at the readability resolution), select the image part that he or she wants to display in order to read it. When the position of the cursor is validated, the image band selected by the cursor is displayed. The user can then scroll through the reading area in the transmitted image of the document page, for example by then actuating the command keys of the terminal enabling the cursor to be moved.

In another alternative of the invention, the user has the possibility of adapting the degree of enlargement of the image, for example, when the document page to be displayed is an image or contains areas of text in smaller characters that cannot be read at the resolution chosen by the adaptation module when converting the document page into an image. In the latter case, it is possible to display a cursor indicating to the user that he or she can obtain the text area marked by the cursor with a resolution suitable for reading this text area on the screen of his or her terminal.

In another alternative of the invention, the adaptation module is designed to allow the user to provide the terminal with files containing visual components of different formats. For example, if a document page contains images and text, the adaptation module can isolate the image and provide a plurality of blocks of different formats, namely, for example, GIF for the text portions and JPEG for the images.

In another alternative of the invention, the adaptation module, upon the user's command, extracts the text from the consulted page or area of the document, and transmits it to the terminal so that it can be displayed using the text display capabilities of the terminal, without of course respecting the layout of the document. It is also possible to extract, from the consulted page or area, appended information, in particular on the structure of the document.

1. Method for adapting a document so as to make it viewable on a terminal (11) having limited display capabilities, which method includes the following steps of:
determining (21) processing and display capabilities of the terminal,
converting (23) a page of a document into a graphic or semi-graphic format chosen on the basis of the processing and/or display capabilities of the terminal, and
at least partially transmitting (25, 27) the image of the converted document page to the terminal,
characterized in that it includes steps consisting of analyzing (22, 30) the document page to be displayed by the terminal (11) so as to determine its characteristics, wherein the image resulting from the conversion has a resolution selected on the basis of the characteristics of the document, so that the contents of the document page can be read on the screen of the terminal.

2. Method according to claim 1, characterized in that the determination (21) of the processing and display capabilities of the terminal comprises a step of determining a display axis corresponding to an axis of a larger dimension of an image capable of being displayed by the terminal (11), wherein the analysis of the document page to be displayed comprises a step of determining a reading direction of the document page, and the conversion of the document page is followed by a step of adapting the image resulting from the conversion, consisting of making the reading direction of the document page coincide with the display axis of the terminal.

3. Method according to claim 1, characterized in that it also includes a step (26) of extracting, from the image resulting from the conversion, a band of which the dimensions correspond to the maximum dimensions of an image capable of being displayed by the terminal, and of which the orientation in the image corresponds to the reading axis of the document page, which image band is transmitted to the terminal.

4. Method according to claim 1, characterized in that the resolution of the image generated by the conversion of a document page is determined on the basis of the size of alphanumeric characters present in the document page and on the basis of the dimensions of the page.

5. Method according to claim 1, characterized in that it includes a preliminary step of selecting a portion of a document page to be displayed on the screen of the terminal (11) including steps consisting of converting the document page into a reduced image having a format compatible with the processing and display capabilities of a terminal, and with a resolution selected so that the entire image can be displayed by the terminal, and transmitting the reduced image of the page to the terminal, wherein the user of the terminal then has the possibility of selecting an area of the displayed image, which selected area of the document page is then converted to a resolution selected on the basis of the characteristics of the document page, so that the contents of the document page can be read on the screen of the terminal.

6. Method according to claim 1, characterized in that if the document page is an image representing text, the analysis of the document page includes steps of recognizing the alphanumeric characters present in the document page and determining a main size of the recognized alphanumeric characters, with the resolution of the image generated by the conversion of a document page being determined on the basis of the main size obtained.

7. Method according to claim 1, characterized in that the analysis of the document page consists of separating images and text contained on the page, wherein the conversion of the document page consists of generating, based on the text, images in an adapted format, and converting the format of the images so that they can be viewed on the terminal.

8. System for adapting a document so as to make it viewable on a terminal having limited display capabilities, which system includes an adaptation module (15) comprising means (13) for determining processing and display capabilities of a terminal (11), and means (17) for converting a page of a document into a graphic or semi-graphic format selected on the basis of the processing and display capabilities of the terminal, which system also includes means for at least partially transmitting the image of the converted document page to the terminal, characterized in that the adaptation module (15) also includes means (18) for analyzing the document page to be displayed by the terminal (11), so as to determine its characteristics, wherein the image resulting from the conversion has a resolution selected on the basis of the characteristics of the document, so that the contents of the document page can be read on the display screen of the terminal.

9. System according to claim 8, characterized in that the means for determining the processing and display capabilities of the terminal include means for determining a display axis corresponding to an axis of a larger dimension of an image capable of being displayed by the terminal, wherein the means for analyzing the document page to be displayed comprise means for determining a reading direction of the document page, the adaptation module (15) includes means for adapting the image resulting from the conversion causing the reading direction of the document page to coincide with the display axis of the terminal.

10. System according to claim 8, characterized in that the adaptation module is integrated in a web server (12) delivering documents to mobile terminals (11).

11. System according to claims claim 1, characterized in that the adaptation module is integrated in a web server (12) delivering documents to mobile terminals (11).

12. System according to claim 8, characterized in that the adaptation module (15) is integrated in a gateway (4) providing the interconnection between a mobile telephone network (2) to which the terminals are capable of being connected, and a data transmission network (5) providing access to documents capable of being viewed on the terminals.

13. System according to claim 8, characterized in that the adaptation module (15) is integrated in a specialized server (10) connected to a data transmission network (5) providing access to documents capable of being viewed on the terminals (11), wherein the terminals are mobile terminals capable of being connected to a mobile telephone network (2) interconnected with the data transmission network.

14. Method according to claim 2, characterized in that it also includes a step (26) of extracting, from the image resulting from the conversion, a band of which the dimensions correspond to the maximum dimensions of an image capable of being displayed by the terminal, and of which the orientation in the image corresponds to the reading axis of the document page, which image band is transmitted to the terminal.

15. Method according to claim 2, characterized in that the resolution of the image generated by the conversion of a document page is determined on the basis of the size of alphanumeric characters present in the document page and on the basis of the dimensions of the page.

16. Method according to claim 3, characterized in that the resolution of the image generated by the conversion of a document page is determined on the basis of the size of alphanumeric characters present in the document page and on the basis of the dimensions of the page.

17. Method according to claim 2, characterized in that it includes a preliminary step of selecting a portion of a document page to be displayed on the screen of the terminal (11) including steps consisting of converting the document page into a reduced image having a format compatible with the processing and display capabilities of a terminal, and with a resolution selected so that the entire image can be displayed by the terminal, and transmitting the reduced image of the page to the terminal, wherein the user of the terminal then has the possibility of selecting an area of the displayed image, which selected area of the document page is then converted to a resolution selected on the basis of the characteristics of the document page, so that the contents of the document page can be read on the screen of the terminal.

18. Method according to claim 3, characterized in that it includes a preliminary step of selecting a portion of a document page to be displayed on the screen of the terminal (11) including steps consisting of converting the document page into a reduced image having a format compatible with the processing and display capabilities of a terminal, and with a resolution selected so that the entire image can be displayed by the terminal, and transmitting the reduced image of the page to the terminal, wherein the user of the terminal then has the possibility of selecting an area of the displayed image, which selected area of the document page is then converted to a resolution selected on the basis of the characteristics of the document page, so that the contents of the document page can be read on the screen of the terminal.

19. Method according to claim 4, characterized in that it includes a preliminary step of selecting a portion of a document page to be displayed on the screen of the terminal (11) including steps consisting of converting the document page into a reduced image having a format compatible with the processing and display capabilities of a terminal, and with a resolution selected so that the entire image can be displayed by the terminal, and transmitting the reduced image of the page to the terminal, wherein the user of the terminal then has the possibility of selecting an area of the displayed image, which selected area of the document page is then converted to a resolution selected on the basis of the characteristics of the document page, so that the contents of the document page can be read on the screen of the terminal.

20. Method according to claim 2, characterized in that if the document page is an image representing text, the analysis of the document page includes steps of recognizing the alphanumeric characters present in the document page and determining a main size of the recognized alphanumeric characters, with the resolution of the image generated by the conversion of a document page being determined on the basis of the main size obtained.
